(19) United States
(12) Patent Application Publication
(10) Pub. No.: US 2007/0245381 A1
(43) Pub. Date: Oct. 18, 2007

(54) Broadcasting receiving device

(75) Inventor: Yoshihisa Nagamura, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/727,886

(22) Filed: Mar. 28, 2007

(30) Foreign Application Priority Data
Mar. 28, 2006 (JP) 2006-087216

(51) Int. Cl. G06F 13/00; G06F 3/00; H04N 5/445

(52) U.S. Cl. 725/53; 725/52

(57) ABSTRACT

A broadcasting receiving device include: an EPG obtaining unit that obtains EPG information; a control unit that extracts keywords from various types of information of the EPG information and counts a number of each of the extracted keywords in the entire or a part of the various types of information; and a display signal generating unit that generates a signal for displaying keywords on a display device depending on the counted number.

This application is based on Japanese Patent Application No. 2006-087216 Mar. 28, 2006, the contents of which are hereby incorporated by reference.

### BACKGROUND OF THE INVENTION

1. Field of the Invention

The present invention relates to a broadcasting receiving device.

2. Description of Related Art

Recently, there is a widespread broadcasting receiving device that receives a broadcasting wave on which electronic program guide (EPG) information is superimposed and utilizes the obtained EPG information for various functions.

As an example of the broadcasting receiving device that utilizes the EPG information, for example, JP-A-2003-179827 discloses a broadcasting receiving device that calculates a number of matching between a keyword entered by a user and a word in text information indicating program contents of the EPG information, so that a list of program titles are displayed in the descending order of the number.

According to this broadcasting receiving device, the user first enters a keyword indicating things that is currently in fashion for searching programs having a deep relationship with the keyword.

However, in the case of the broadcasting receiving device as described in the above-mentioned JP-A-2003-179827, the user has to check items that are currently in fashion from other information sources and to enter the keyword thereof. In other words, the user cannot know what is currently in fashion publicly only by using the broadcasting receiving device.

### SUMMARY OF THE INVENTION

In view of the above described problem, it is an object of the present invention to provide a broadcasting receiving device that enables a user to know what is currently in fashion publicly.

To attain the above described object, a broadcasting receiving device in accordance one aspect of the present invention includes: an EPG obtaining unit that obtains EPG information; a control unit that extracts keywords from various types of information of the EPG information and counts a number of each of the extracted keywords in the entire or a part of the various types of information; and a display signal generating unit that generates a signal for displaying keywords on a display device depending on the counted number.

According to this first structure, the user can know what is currently in fashion publicly.

Further, according to second aspect of the present invention, the broadcasting receiving device that has the above described first structure is characterized by a structure in that when any one of the displayed keywords is selected and confirmed with an operating unit, the control unit searches broadcasting programs having the selected keywords included in any of the EPG information and having broadcasting end time that is later than the present time, and the display signal generating unit generates a signal for displaying information about broadcasting program of the search result.

According to this second structure, the user can check a broadcasting program that is on the air at present or will be on the air from this time on and that has a relationship with a keyword in which the user is interested in among the keywords obtained as described above.

Still further, according to third aspect of the present invention, the broadcasting receiving device that has the above described second structure is characterized by a structure in that when the displayed broadcasting program of the search result is selected and confirmed with the operating unit and if the present time is between broadcasting start time and broadcasting end time of the broadcasting program, the display signal generating unit generates a signal for displaying an image for selecting watching of the broadcasting program, and when a display confirmation operation is performed with the operating unit, the display signal generating unit generates a signal for displaying pictures of the broadcasting program.

According to this third structure, the user can watch a broadcasting program that is on the air at present and has a relationship with a keyword in which the user is interested in among the keywords obtained as described above.

Still further, according to fourth aspect of the present invention, the broadcasting receiving device that has the above described second structure further including a memory unit and a recording unit. And it is characterized by a structure in that when the displayed broadcasting program of the search result is selected and confirmed with the operating unit and if the present time is before the broadcasting start time of the broadcasting program, the display signal generating unit generates a signal for displaying at least one of an image for selecting watching reservation and an image for selecting recording reservation, when the watching reservation is selected and confirmed, the control unit makes the memory unit store the broadcasting start time of the broadcasting program, and when the present time matches the broadcasting start time, the display signal generating unit generates a signal for displaying pictures of the broadcasting program, and when the recording reservation is selected and confirmed with the operating unit, the control unit makes the memory unit store the broadcasting start time of the broadcasting program, and when the present time matches the broadcasting start time, the recording unit records picture and audio information of the broadcasting program on a recording medium.

According to this fourth structure, the user can set watching reservation or recording reservation of a broadcasting program that has a relationship with a keyword in which the user is interested in among the keywords obtained as described above, with a simple operation so that watching or recording can be performed when the broadcasting start time comes.

According to the broadcasting receiving device of the present invention, the user can know what is currently in fashion publicly.

### BRIEF DESCRIPTION OF THE DRAWINGS

FIG. 1 is a block diagram of a hard disk recorder according to the present invention.

FIG. 2 is a diagram to show one example of a database based on EPG information.

FIG. 3 is a diagram to show an example of a display of a search result of programs in fashion.

FIG. 4 is a diagram to show an example of a display of information about broadcasting programs having a relationship with a keyword.

FIG. 5 shows an example of a display of a button lettered “program view.”

FIG. 6 shows an example of a display of a button lettered “watch reservation” and a button lettered “record reservation”.

FIG. 7 shows an example of a display of a dialog box describing that the broadcasting program has already finished.

FIG. 8 is a flowchart concerning an operation of searching programs in fashion and accompanying operations.

### DETAILED DESCRIPTION OF THE PREFERRED EMBODIMENTS

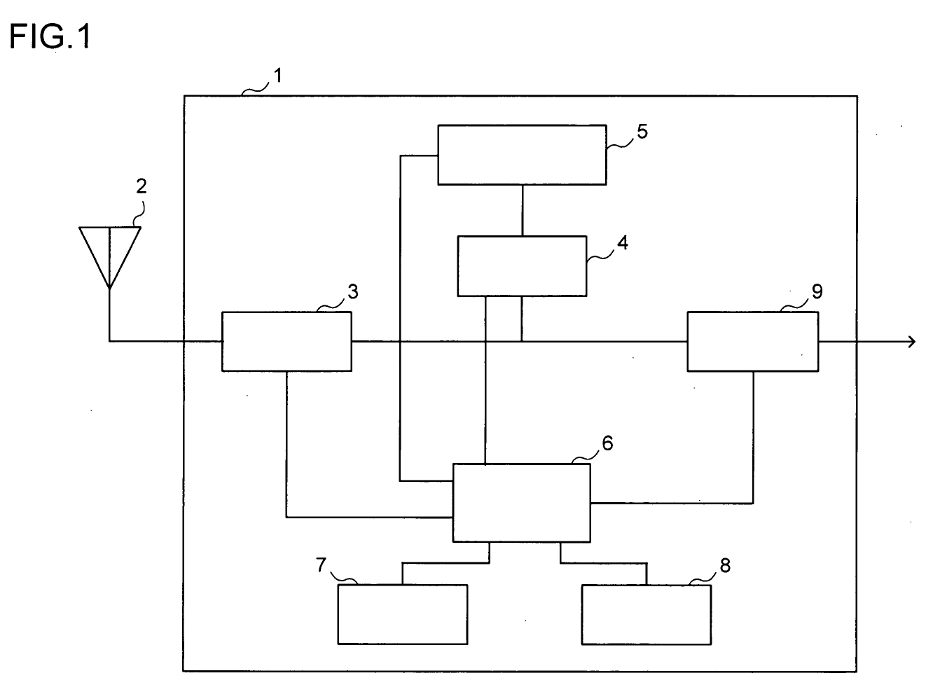

Hereinafter, an example of an embodiment of the present invention will be described with reference to the attached drawings. FIG. 1 is a block diagram of a hard disk recorder 1 according to the present invention. It should be understood that the present invention can be applied to a broadcasting receiving device such as a television set or a DVD recorder though the following embodiment is described about a hard disk recorder.

An antenna 2 receives a broadcasting wave and converts it into a high frequency signal, which is sent to a tuner 3. The tuner 3 extracts a high frequency signal of a channel designated by a control portion (control unit) 6 from high frequency signals supplied from the antenna 2 and delivers a picture signal and an audio signal. Further, the tuner (EPG obtaining unit) 3 extracts EPG information from the high frequency signal supplied from the antenna 2 and delivers it.

An MPEG codec 4 compresses a picture signal and an audio signal supplied from the tuner 3 and expands a compressed picture signal and a compressed audio signal that a hard disk drive 5 reads out from the hard disk. The hard disk drive (recording unit) 5 records the picture signal and the audio signal that are compressed by the MPEG codec 4 on the hard disk that is housed in the hard disk drive 5 and reads out the compressed picture signal and the compressed audio signal from the hard disk. The hard disk drive (recording unit) 5 also records the database based on the EPG information obtained by the tuner 3 on the hard disk and reads out it from the hard disk.

An on screen display (OSD) portion (display signal generating unit) 9 generates a graphic signal and a character signal based on an output from the control portion 6 and combines them with a picture signal supplied from the tuner 3 or the MPEG codec 4 so as to generate a video signal, which is supplied to a display device such as TV set (not shown). An internal clock 7 measures time. A remote controller receiving portion 8 receives an infrared signal from a remote controller (not shown) and sends its code signal to the control portion 6.

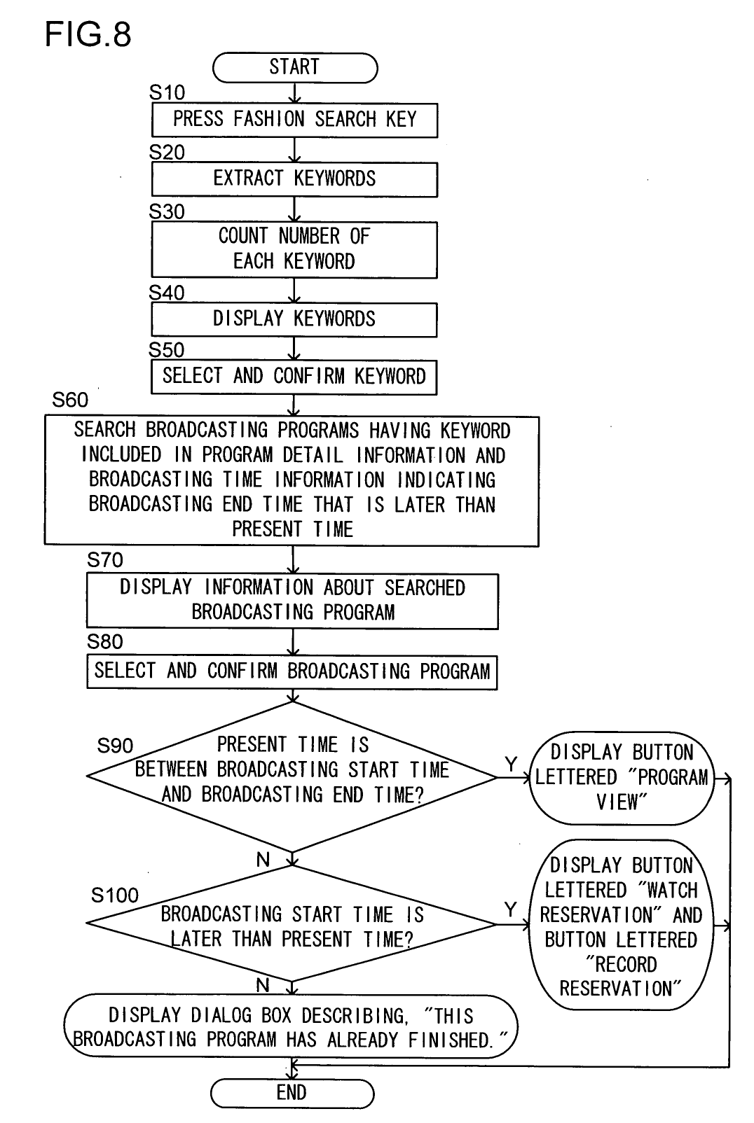

A feature function of the hard disk recorder 1 according to the present invention having the structure described above is a searching function of programs in fashion, which will be described below in accordance with the flowchart shown in FIG. 8.

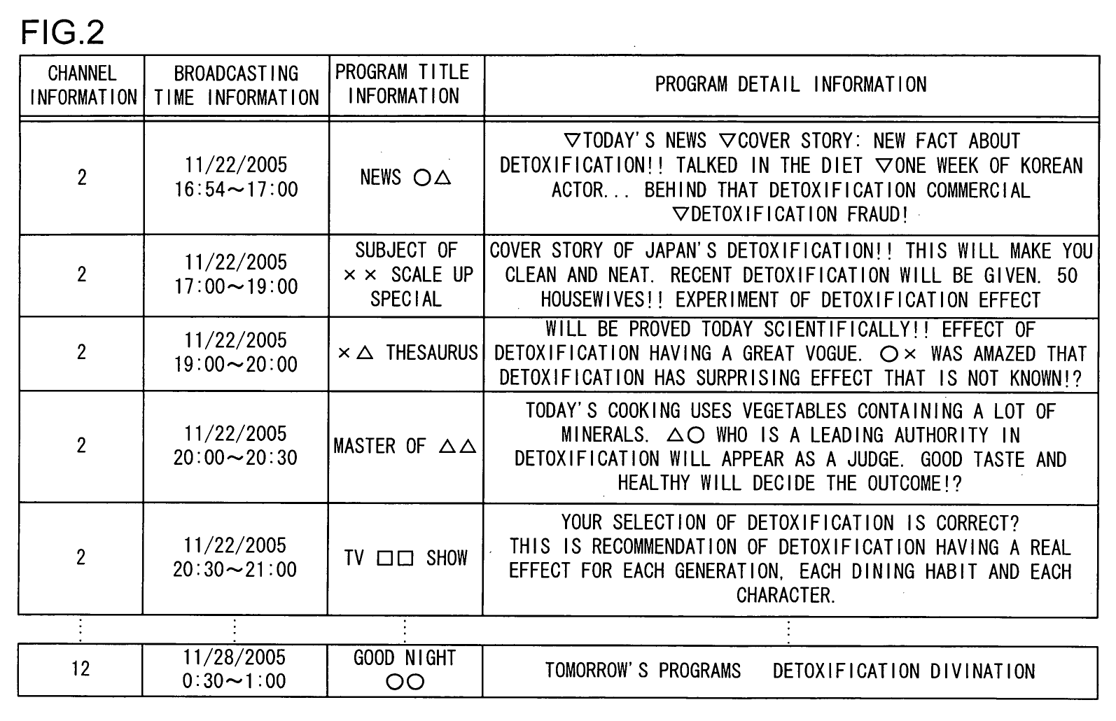

At this point, it is supposed that the database based on the EPG information obtained by the tuner 3 is recorded on the hard disk of the hard disk drive 5. As shown in FIG. 2, the database based on the EPG information is made up of channel information, broadcasting time information, program title information and program detail information.

First in the step S10, a fashion search key of the remote controller (not shown) is pressed, so that the remote controller receiving portion 8 sends a code signal corresponding to the operation to the control portion 6. In the step S20, the control portion 6 extracts keywords from the entire of the program detail information based on the database stored on the hard disk. The extraction of keywords may be performed by using various known methods such as a method of utilizing a morphological analysis.

Next in the step S30, the control portion 6 counts a number of each of the keywords extracted in the above operation in the entire of the program detail information. Then in the step S40, the control portion 6 sorts the result of the counted numbers in the descending order, which is supplied as an output to the OSD portion 9. The OSD portion 9 generates a video signal based on the output and sends it to the display device (not shown). The display device displays the keywords arranged in accordance with the counted numbers, and ordinal levels are also displayed next to the keywords. In addition, a background of a keyword at a first order is displayed with color.

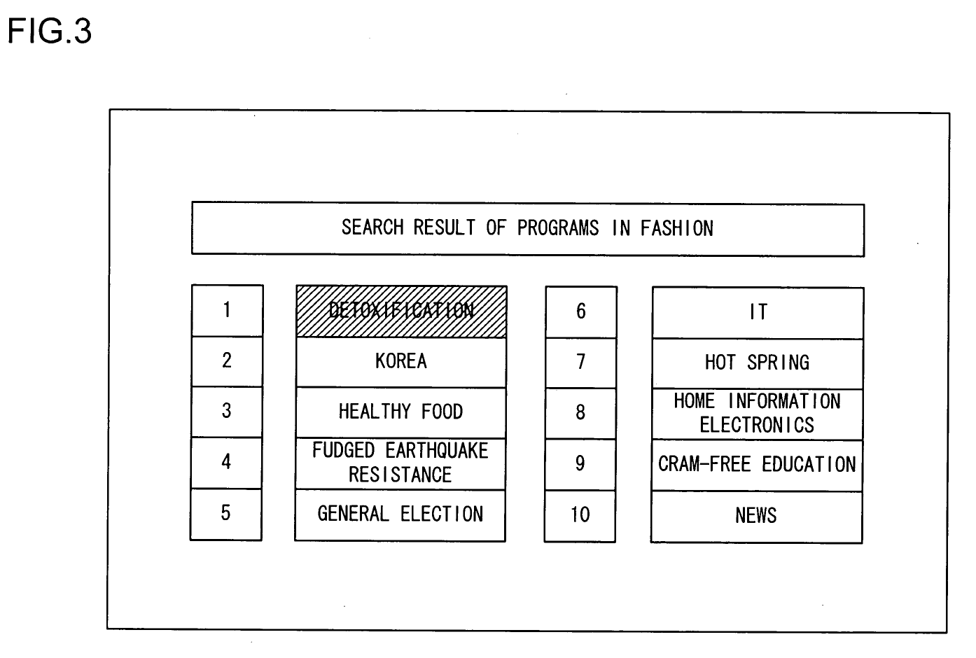

For example, based on the database as shown in FIG. 2, keywords including “detoxification”, “Korea”, “healthy food”, “fudged earthquake resistance”, “general election”, “IT”, “hot spring”, “home information electronics”, “cram-free education” and “news” are extracted from the entire of the program detail information. The numbers of each of the keywords in the entire of the program detail information are supposed to be as follows, for example. There are twelve of “detoxification”, eleven of “Korea”, nine of “healthy food”, seven of “fudged earthquake resistance”, six of “general election”, five of “IT”, four of “hot spring”, three of “home information electronics”, two of “cram-free education” and one of “news” in the entire of the program detail information. Then, the display is as shown in FIG. 3.

It may be considered that the more the number of the keyword in the entire of the program detail information, the more the item is currently in fashion publicly. Therefore, the user can know what is currently in fashion publicly from this display.

At this point, it is possible to extract the keywords from the entire of the program title information and the program detail information so as to count the number of each of the extracted keywords in the entire of the program title information and the program detail information. In addition, it is possible to adopt a structure in which keywords are extracted and the number of each keyword is counted in the entire of the program detail information or the entire of the program title information and the program detail information of the broadcasting program having channel information, broadcasting time information or program title information which match the condition set by the user.

At this point, when a cursor key of the remote controller is pressed, backgrounds of the keywords are displayed in color in turn based on the output of the control portion 6 to the OSD portion 9. When the ENTER key of the remote controller is pressed in a state where a background of a certain keyword is displayed in color in the step S50 in FIG. 8, the control portion 6 searches broadcasting programs having a keyword included in the program detail information and having broadcasting time information indicating the broadcasting end time that is later than the present time which is obtained from the internal clock 7, based on the database in the step S60. Then, the control portion 6 supplies channel information, broadcasting time information, program title information and program detail information of the searched broadcasting program as an output to the OSD portion 9 in the step S70. The OSD portion 9 generates a video signal based on the output and sends it to the display device (not shown). The display device displays a list including the channel, broadcasting time, the program title, and program detail of the broadcasting program searched as described above. In addition, backgrounds of items of the broadcasting program at the uppermost position are displayed in color.

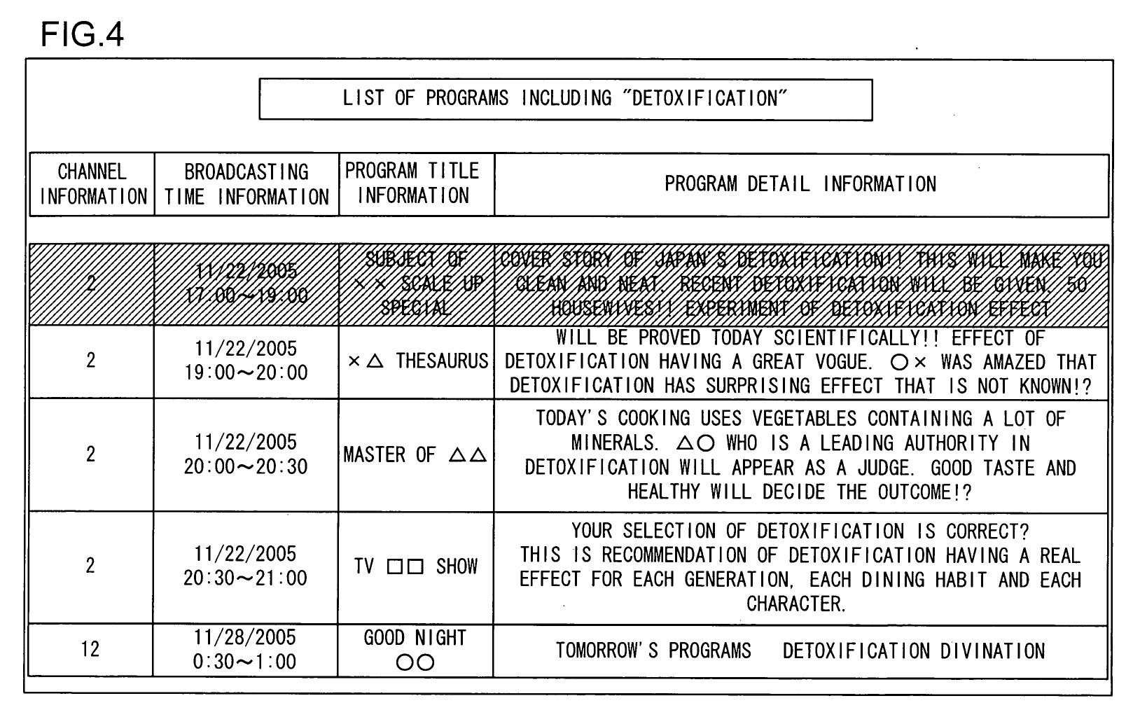

FIG. 4 shows a display result when the ENTER key of the remote controller is pressed at 18:00 on Nov. 22, 2005 in a state where the background of the keyword “detoxification” is displayed in color as shown in FIG. 3. It is understood from FIG. 2 that broadcasting program having program detail information including “detoxification” and having broadcasting time information indicating the broadcasting end time that is later than the present time 18:00 on Nov. 22, 2005 are “subject of ×× scale up special”, “×Δ thesaurus”, “master of ΔΔ”, “TV □□ show” and “good night ◯◯” (however, it is supposed that program detail information of any broadcasting program between “TV □□ show” and “good night ◯◯” does not include “detoxification” in FIG. 2). Therefore, a list including channels, broadcasting times, program titles and program details of these broadcasting programs is shown in FIG. 4.

At this point, it is possible to adopt a structure in which if the extraction of keywords and count of the number thereof are performed for the program title information and the entire of the program detail information as described above, the control portion 6 searches broadcasting programs having a keyword included in at least one of the program title information and the program detail information and having broadcasting time information indicating the broadcasting end time that is later than the present time obtained from the internal clock 7 based on the database when the ENTER key of the remote controller is pressed in a state where a background of the keyword is displayed in color as described above.

In addition, it is possible to adopt a structure in which if the extraction of keywords and count of the number thereof are performed for the entire of the program detail information or the entire of the program title information and the program detail information of the broadcasting programs selected by a condition set by the user as described above, the control portion 6 searches broadcasting programs having a keyword included in program detail information and having broadcasting time information indicating the broadcasting end time that is later than the present time obtained from the internal clock 7 or broadcasting programs having a keyword included in at least one of the program title information and the program detail information and having broadcasting time information indicating the broadcasting end time that is later than the present time obtained from the internal clock 7 among the selected broadcasting programs described above based on the database when the ENTER key of the remote controller is pressed in a state where a background of the keyword is displayed in color as described above.

At this point, when the cursor key of the remote controller is pressed, backgrounds of the items of the broadcasting programs are displayed in color in turn based on the output of the control portion 6 to the OSD portion 9. When the ENTER key of the remote controller is pressed in a state where backgrounds of items of a certain broadcasting program are displayed in color in the step S80, the control portion 6 decides whether or not the present time obtained from the internal clock 7 is between the broadcasting start time and the broadcasting end time of the broadcasting program whose backgrounds are displayed in color in the step S90. If the present time is between the broadcasting start time and the broadcasting end time (Y in the step S90), the control portion 6 delivers the comparison result as an output to the OSD portion 9, and the OSD portion 9 generates a video signal based on the output and sends it to the display device (not shown). Then, the display device displays a dialog box having a button lettered “program view” at the front.

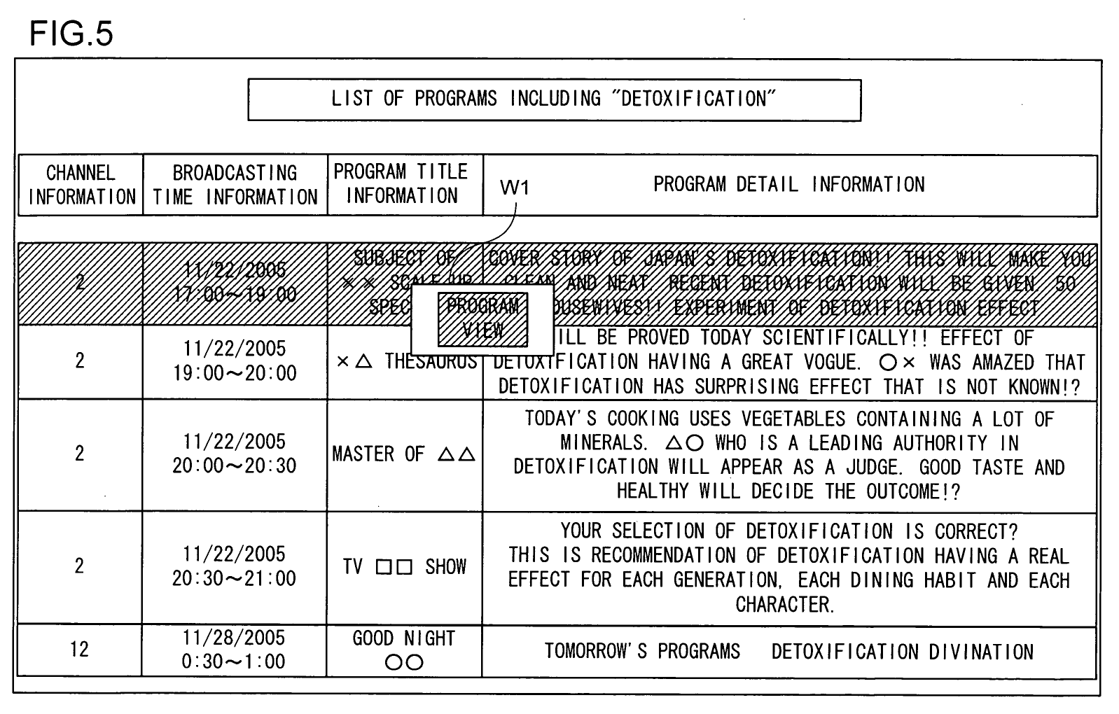

FIG. 5 shows a display result when the ENTER key of the remote controller is pressed at 18:05 on Nov. 22, 2005 in a state where the backgrounds of items of the broadcasting program “subject of ×× scale up special” are displayed in color as shown in FIG. 4. The present time that is 18:05 on Nov. 22, 2005 is between the broadcasting start time that is 17:00 on Nov. 22, 2005 and the broadcasting end time that is 19:00 on Nov. 22, 2005 whose backgrounds are displayed in color. Therefore, a dialog box W1 having a button lettered “program view” is displayed at the front as shown in FIG. 5.

At this point, the ENTER button of the remote controller is pressed, the control portion 6 instructs the tuner 3 to select the channel whose background is displayed in color (channel 2 in the case of FIG. 5). The tuner 3 extracts the high frequency signal of the channel designated by the control portion 6 from the high frequency signals supplied from the antenna 2 and delivers the picture signal to the OSD portion 9. Then, the OSD portion 9 delivers the video signal to the display device based on the picture signal supplied from the tuner 3 so that the display device displays pictures of the broadcasting program.

Thus, the user can watch a broadcasting program that is on the air at present and has a relationship with a keyword in which the user interests among keywords obtained by searching programs in fashion with a simple operation.

In addition, if the present time does not exist between the broadcasting start time and the broadcasting end time whose backgrounds are displayed in color (N in the step S90) in the above-mentioned step S90, the control portion 6 decides whether or not the broadcasting start time whose background is displayed in color is later than the present time in the step S100. If the broadcasting start time is later than the present time (Y in the step S100), the control portion 6 delivers the comparison result as an output to the OSD portion 9, and the OSD portion 9 generates the video signal based on the output and sends it to the display device (not shown). Then, the display device displays a dialog box having a button lettered “watch reservation” and a button lettered “record reservation” at the front. In this case, the button lettered “watch reservation” is displayed in color.

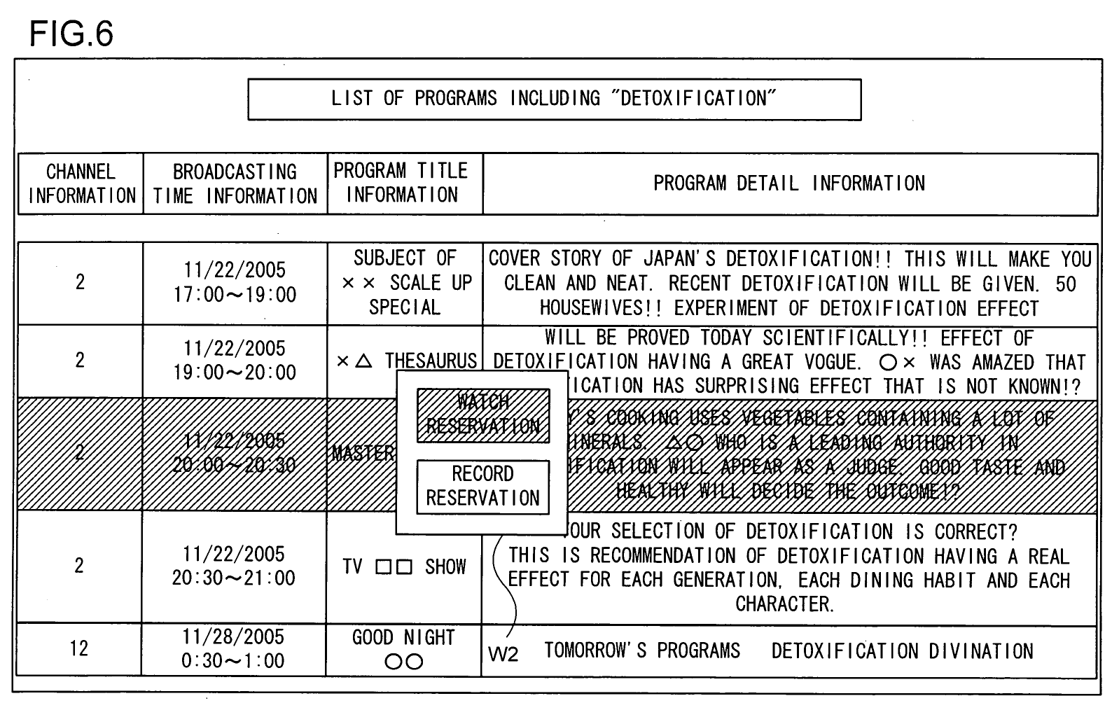

FIG. 6 shows a display result when the ENTER key of the remote controller is pressed at 18:05 on Nov. 22, 2005 in a state where backgrounds of items of the broadcasting program “master of ΔΔ” are displayed in color as shown in FIG. 4 by the operation of the cursor key of the remote controller. Because 20:00 on Nov. 22, 2005 that is the broadcasting start time whose background is displayed in color is later than 18:05 on Nov. 22, 2005 that is the present time, a dialog box W2 having the button lettered “watch reservation” and the button lettered “record reservation” is displayed at the front as shown in FIG. 6.

At this point, when the cursor key of the remote controller is operated, one of the button lettered “watch reservation” and the button lettered “record reservation” is displayed in color. If the ENTER key of the remote controller is pressed in a state where the button lettered “watch reservation” is displayed in color, the control portion 6 make a memory (not shown) store channel information indicating a channel whose background is displayed in color (channel 2 in the case of FIG. 6) and broadcasting start time information indicating the broadcasting start time (20:00 on Nov. 22, 2005 in the case of FIG. 6) whose backgrounds are displayed in color. After that, if the present time obtained from the internal clock 7 matches the broadcasting start time indicated by broadcasting start time information stored in the memory, the control portion 6 instructs the tuner 3 to select the channel designated by the channel information stored in the memory. Then, the tuner 3 extracts a high frequency signal of the channel designated by the control portion 6 from the high frequency signals supplied from the antenna 2 and delivers the picture signal to the OSD portion 9. Then, the OSD portion 9 delivers the video signal to the display device based on the picture signal supplied from the tuner 3 so that the display device displays pictures of the broadcasting program.

In addition, if the ENTER key of the remote controller is pressed in a state where the button lettered “record reservation” is displayed in color, the control portion 6 makes the memory (memory unit, not shown) store the channel information indicating the channel whose background is displayed in color (channel 2 in the case of FIG. 6) and the broadcasting start time information indicating the broadcasting start time whose background is displayed in color (20:00 on Nov. 22, 2005 in the case of FIG. 6). After that, if the present time obtained from the internal clock 7 matches the broadcasting start time indicated by the broadcasting start time information stored in the memory, the control portion 6 instructs the tuner 3 to select the channel indicated by the channel information stored in the memory. Then, the tuner 3 extracts a high frequency signal of the channel designated by the control portion 6 from the high frequency signals supplied from the antenna 2 and delivers the picture signal and the audio signal to the MPEG codec 4. The MPEG codec 4 compresses the picture signal and the audio signal supplied from the tuner 3, and the hard disk drive 5 records the picture signal and the audio signal compressed by the MPEG codec 4 on the hard disk.

Thus, the user can do the watching reservation and the recording reservation of the broadcasting program having a relationship with a keyword in which the user is interested among the keywords obtained by searching programs in fashion with a simple operation, so that watching or recording can be performed when the broadcasting start time comes.

In addition, if the broadcasting start time whose background is displayed in color is not later than the present time (N in the step S100) in the above-mentioned step S100, the control portion 6 delivers the decision result as an output to the OSD portion 9, and the OSD portion 9 generates the video signal based on the output and sends it to the display device (not shown). Then, the display device displays a dialog box describing, “This broadcasting program has already finished.” at the front.

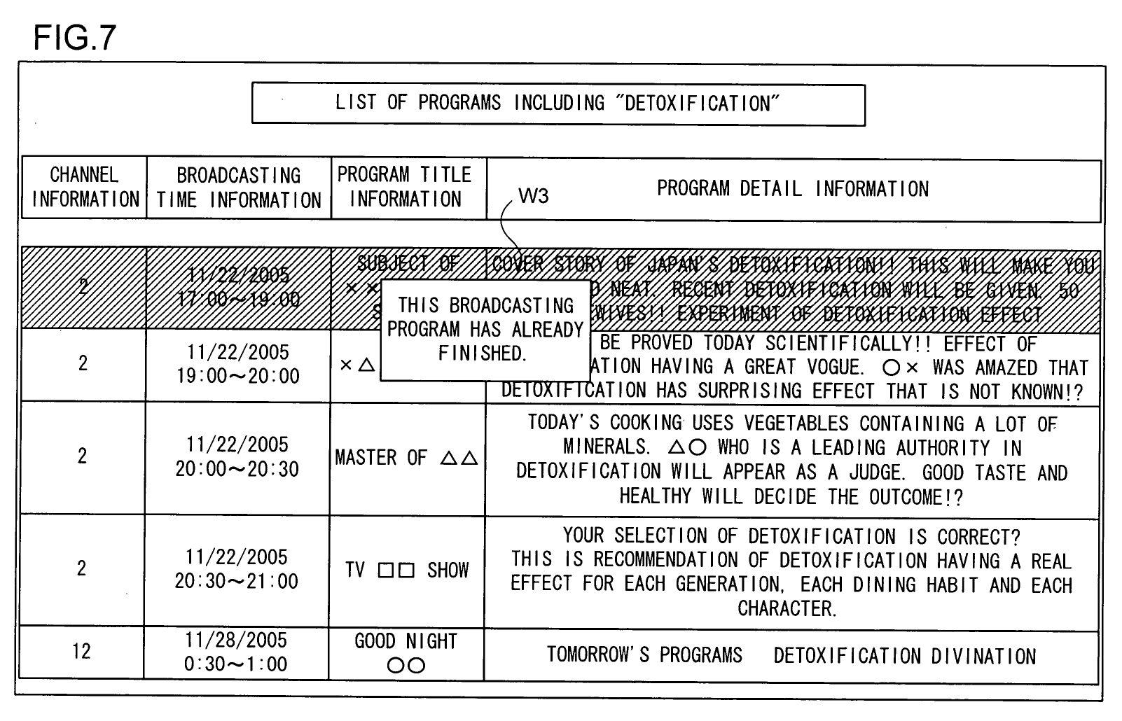

FIG. 7 shows a display result when the ENTER key of the remote controller is pressed at 19:05 on Nov. 22, 2005 in a state where the backgrounds of the items of the broadcasting program “subject of ×× scale up special” are displayed in color as shown in FIG. 4. The present time that is 19:05 on Nov. 22, 2005 does not exist between the broadcasting start time that is 17:00 on Nov. 22, 2005 and the broadcasting end time that is 19:00 on Nov. 22, 2005 whose backgrounds are displayed in color, and the broadcasting start time is not later than the present time. Therefore, a dialog box W3 describing, “This broadcasting program has already finished.” is displayed at the front.

As above described, the present invention is explained with reference to the accompanied drawings. Although the above described embodiment is explained based on a specific combination of the claimed element, the present invention should not be understood only to the embodiment described above. Those who skilled in the arts would appreciate that proper modification is possible without departing from the scope and spirit of the claimed invention.

For example, in the above described embodiment, the memory unit is utilized to store the program start time, however, it is possible that the hard disk recorder is utilized to store the program start time.

What is claimed is:

1. A broadcasting receiving device comprising:
an EPG obtaining unit that obtains EPG information;
a control unit that extracts keywords from various types of information of the EPG information and counts a number of each of the extracted keywords in the entire or a part of the various types of information; and
a display signal generating unit that generates a signal for displaying keywords on a display device depending on the counted number.

2. The broadcasting receiving device according to claim 1, wherein when any one of the displayed keywords is selected and confirmed with an operating unit, the control unit searches broadcasting programs having the selected keyword included in any of the EPG information and having broadcasting end time that is later than the present time, and the display signal generating unit generates a signal for displaying information about broadcasting program of the search result.

3. The broadcasting receiving device according to claim 2, wherein
when the displayed broadcasting program of the search result is selected and confirmed with the operating unit and if the present time is between broadcasting start time and broadcasting end time of the broadcasting program, the display signal generating unit generates a signal for displaying an image for selecting watching of the broadcasting program, and
when a display confirmation operation is performed with the operating unit, the display signal generating unit generates a signal for displaying pictures of the broadcasting program.

4. The broadcasting receiving device according to claim 2, further comprising a memory unit and a recording unit, wherein
when the displayed broadcasting program of the search result is selected and confirmed with the operating unit and if the present time is before the broadcasting start time of the broadcasting program, the display signal generating unit generates a signal for displaying at least one of an image for selecting watching reservation and an image for selecting recording reservation,
when the watching reservation is selected and confirmed, the control unit makes the memory unit store the broadcasting start time of the broadcasting program, and when the present time matches the broadcasting start time, the display signal generating unit generates a signal for displaying pictures of the broadcasting program, and
when the recording reservation is selected and confirmed with the operating unit, the control unit makes the memory unit store the broadcasting start time of the broadcasting program, and when the present time matches the broadcasting start time, the recording unit records picture and audio information of the broadcasting program on a recording medium.

5. A broadcasting receiving device comprising:
an EPG obtaining unit that obtains EPG information;
a control unit that extracts keywords from various types of information of the EPG information and counts a number of each of the extracted keywords in the entire or a part of the various types of information;
a display signal generating unit that generates a signal for displaying keywords on a display device depending on the counted number;
a memory unit; and
a recording unit, wherein
when any one of the displayed keywords is selected and confirmed with an operating unit, the control unit searches broadcasting programs having the selected keyword included in any of the EPG information and having broadcasting end time that is later than the present time, and the display signal generating unit generates a signal for displaying information about broadcasting program of the search result,
when the displayed broadcasting program of the search result is selected and confirmed with the operating unit and if the present time is between broadcasting start time and broadcasting end time of the broadcasting program, the display signal generating unit generates a signal for displaying an image for selecting watching of the broadcasting program,
when a display confirmation operation is performed with the operating unit, the display signal generating unit generates a signal for displaying pictures of the broadcasting program,
if the present time is before the broadcasting start time of the broadcasting program, the display signal generating unit generates a signal for displaying at least one of an image for selecting watching reservation and an image for selecting recording reservation,
When an image indicating the watching reservation is selected and confirmed, the control unit makes the memory unit store the broadcasting start time of the broadcasting program, and if the present time matches the broadcasting start time, the display signal generating unit generates a signal for displaying pictures of the broadcasting program, and
When an image indicating the recording reservation is selected and confirmed with the operating unit, the control unit makes the memory unit store the broadcasting start time of the broadcasting program, and when the present time matches the broadcasting start time, the recording unit records picture and audio information of the broadcasting program on a recording medium.
